(19) United States
(12) Patent Application Publication
(10) Pub. No.: US 2025/0013502 A1
(43) Pub. Date: Jan. 9, 2025

(54) METHODS, SYSTEMS, ARTICLES OF MANUFACTURE AND APPARATUS TO ALLOCATE RESOURCES BASED ON WORKLOAD PARAMETERS

(71) Applicants: Alexander Kanevskiy, Espoo (FI); Antti Kervinen, Tampere (FI); Krisztian Litkey, Espoo (FI)

(72) Inventors: Alexander Kanevskiy, Espoo (FI); Antti Kervinen, Tampere (FI); Krisztian Litkey, Espoo (FI)

(21) Appl. No.: 18/887,849

(22) Filed: Sep. 17, 2024

(51) Int. Cl. G06F 9/50

(52) U.S. Cl. CPC G06F 9/505

(57) ABSTRACT

Methods, systems, articles of manufacture, and apparatus are disclosed to allocate resources based on workload parameters. An example apparatus includes interface circuitry, machine-readable instructions, and at least one processor circuit to be programmed by the machine-readable instructions to generate groups of processor cores based on performance capability values, assign a first one of the groups a first computation cost value based on (a) first ones of the performance capability values and (b) a first computation performance objective associated with a workload, and assign a second one of the groups a second computation cost value based on (a) second ones of the performance capability values and (b) a second computation performance objective associated with the workload.

### BACKGROUND

Workloads are provided to one or more computational resources to facilitate task execution. Both the workloads and the computational resources exhibit varying degrees of demand and capability, respectively.

### BRIEF DESCRIPTION OF THE DRAWINGS

FIG. 1 is a block diagram of an example hardware topology in which example resource allocation circuitry operates to allocate resources based on workload parameters.

FIG. 2 is a block diagram of an example implementation of a power-saving grouping of resources generated by the resource allocation circuitry of FIG. 1.

FIG. 3 is a block diagram of an example implementation of a high-performance grouping of resources generated by the resource allocation circuitry of FIG. 1.

FIG. 4 is a block diagram of an example implementation of a core-to-memory grouping generated by the resource allocation circuitry of FIG. 1.

FIG. 5 is a block diagram of an example implementation of the resource allocation circuitry of FIG. 1.

FIGS. 6, 7A and 7B are flowcharts representative of example machine readable instructions and/or example operations that may be executed, instantiated, and/or performed by example programmable circuitry to implement the resource allocation circuitry of FIG. 5.

FIG. 8 is a block diagram of an example processing platform including programmable circuitry structured to execute, instantiate, and/or perform the example machine readable instructions and/or perform the example operations of FIGS. 6, 7A and 7B to implement the resource allocation circuitry of FIG. 5.

FIG. 9 is a block diagram of an example implementation of the programmable circuitry of FIG. 8.

FIG. 10 is a block diagram of another example implementation of the programmable circuitry of FIG. 8.

FIG. 11 is a block diagram of an example software/firmware/instructions distribution platform (e.g., one or more servers) to distribute software, instructions, and/or firmware (e.g., corresponding to the example machine readable instructions of FIGS. 6, 7A and 7B) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Performance of a workload running (executing) on a system (e.g., a platform, a system-on-chip (SoC), a server, etc.) depends on one or more computing resources that are scheduled to handle one or more tasks associated with the workload. The one or more computing resources include, but are not limited to central processing units (CPUs), graphical processing units (GPUs), accelerators, and/or any number of cores thereon. Additionally, performance is also a function of types and/or capabilities of physical memory devices and networking devices. Percentage differences in performance capabilities are caused by, in part, cache contents, core-to-core latencies, data locality in memory devices, and device locality to cores (e.g., CPU cores). Efficiencies can be improved by applying the right device for the right task, such as workload-specific demands that perform relatively better when a particular resource type is assigned (e.g., a GPU assigned for graphics-related processing compared to a general CPU).

Examples disclosed herein allocate computing resources to workloads in a manner that considers a physical topology of the resources and workload expectations. In the event a particular physical topology (e.g., a computing platform) does not permit a relatively efficient match between a workload task and a computing resource, examples disclosed herein identify a next-best resource allocation based on an objective cost value of such resources.

Examples disclosed herein generate data structures to represent connected groupings of computing resources (e.g., CPUs, GPUs, cores, memory, etc.). Each one of the computing resources has an associated classification that reflects its capabilities, such as a high-performance core capable of a finite number of operations per unit of time. Some classifications include a power-saving capability in which operations per unit of time consume relatively less energy (e.g., and/or generate relatively less heat) as compared to the high-performance core. Each connected grouping may include the same computing resources, but such groupings include a separate and unique performance objective that dictates which resources are to be interconnected to best align with the performance objective. For example, a first connected grouping with a power-saving performance objective may group a first set of cores that exhibit a relatively lowest energy consumption metric per computing cycle and a second set of cores that exhibit a relatively higher energy consumption metric per computing cycle. Additionally, the first connected grouping designates a cost values associated with selecting one or more cores from the first set to be relatively lower than selecting one or more cores from the second set. As such, selection of resources for a workload that aligns with a goal of power-saving performance objective will perform better when the lowest cost resources are selected.

On the other hand, a second connected grouping may have a high-performance objective that seeks speed instead of power conservation. While the first set of cores and the second set of cores in both the first connected grouping (power-saving) and the second connected grouping (high-performance) are the same, the associated cost values associated with selecting one or more cores from those sets are different. For instance, when making a selection for a computing resource (e.g., a core) to execute a workload with a high-performance objective, the selection from the second set of cores results in a lower cost penalty than a selection from the first set of cores.

Examples disclosed herein perform a case-by-case selection of relevant groupings when allocating resources for a workload. In particular, selections consider workload preferences (e.g., workload metadata that includes a type of performance objective) and available connected groupings. Examples disclosed herein also recursively perform the selection process in view of relatively lowest cost values, as described in further detail below.

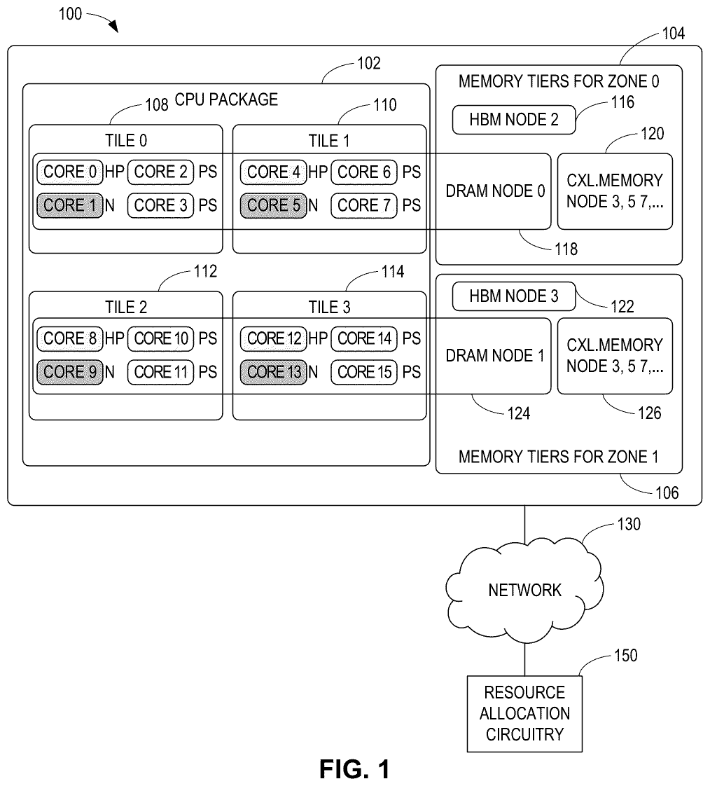

FIG. 1 is a block diagram of an example hardware topology 100 in which example resource allocation circuitry 150 (described in further detail below) operates to allocate resources based on workload parameters. In the illustrated example of FIG. 1, the topology 100 includes an example CPU package 102, an example first tile of cores 108, an example second tile of cores 110, an example third tile of cores 112, and an example fourth tile of cores 114. The illustrated example of FIG. 1 also includes a first zone of memory devices 104 and a second zone of memory devices 106, in which the first zone of memory devices 104 is proximately closer to the first tile of cores 108 and the second tile of cores 110 as compared to the third tile of cores 112 and the fourth tile of cores 114. The relatively proximity between different devices of the example topology 100 is relevant in view of latency characteristics when such devices communicate with each other. For instance, data flow and/or communication between the first zone of memory devices 104 is typically faster with devices having a relatively shorter proximity distance therebetween, such as those devices associated with the first tile of cores 108 and the second tile of cores 110. Similarly, data flow and/or communication between the second zone of memory devices 106 is typically faster with devices associated with the third tile of cores 112 and the fourth tile of cores 114.

In the illustrated example of FIG. 1, the first zone of memory devices 104 includes a first high bandwidth memory (HBM) node 116, a first dynamic random access memory (DRAM) node 118, and a first compute express link (CXL) node 120. In the illustrated example of FIG. 1, the second zone of memory devices 106 includes a second HBM 122, a second DRAM node 124, and a second CXL node 126.

In the illustrated example of FIG. 1, respective cores (labeled “Core 0” through “Core 15”) are associated with a capability metric, such as “high performance,” “normal,” and “power-saving.” Respective cores that have a capability metric type of “high performance” are labeled with “HP,” respective cores that have a capability metric type of “normal” are labeled with “N,” and respective cores that have a capability metric type of “power-saving” are labeled with “PS.”

As described above, data access times for cores closest to a memory zone or farthest from the memory zone will exhibit large differences. However, particular types of memory devices may exhibit greater or lesser latency characteristics based on bandwidth demands, which may make relative distance characteristics less influential.

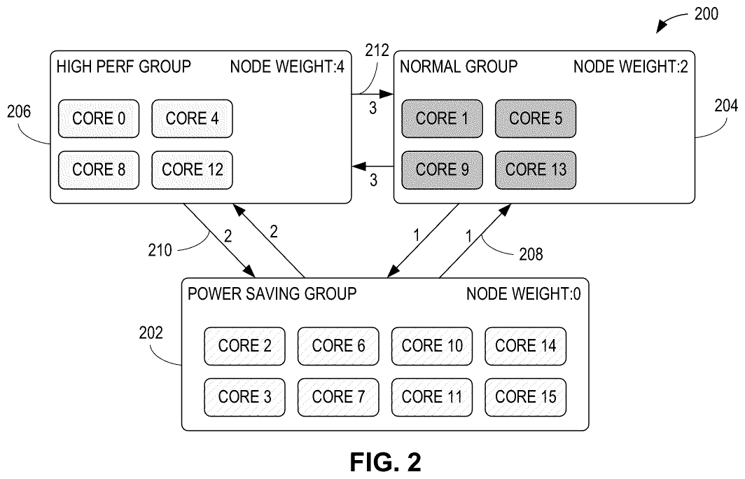

In view of the example topology 100 of FIG. 1, two or more connected groupings are generated by examples disclosed herein. FIG. 2 is a block diagram of an example power-saving grouping 200. In some examples, the power-saving grouping 200 is generated as a data structure. In the illustrated example of FIG. 2, the power-saving grouping 200 includes a power-saving group node 202, a normal group node 204 and a high-performance group node 206. The power-saving grouping 200 configures and/or otherwise structures the power-saving group node 202 to include only those devices (e.g., cores) that exhibit an ability to satisfy performance metrics that match or are similar to power-saving behaviors. As described above, power-saving behaviors include metrics that exhibit a relatively low power consumption per operation (e.g., “op,” “cpu cycle,” etc.) and/or exhibit a relatively low heat generation when compared to other devices. As such, the example power-saving group node 202 includes “Core 2,” “Core 3,” “Core 6,” “Core 7,” “Core 10,” “Core 11,” “Core 14,” and “Core 15.”

The example power-saving grouping 200 also includes the high performance group node 206 to include only those devices (e.g., cores) that exhibit an ability to satisfy performance metrics that match or are similar to high-performance behaviors. In some examples, high-performance behaviors are determined based on a threshold number of operations per unit of time. Generally speaking, high-performance devices generate a relatively greater amount of heat and/or consume a relatively greater amount of energy as compared to the power-saving devices. As such, the example performance group node 206 includes “Core 0,” “Core 4,” “Core 8,” and “Core 12.”

The example power-saving grouping 200 also includes the normal performance group node 204 to include particular devices (e.g., cores) that exhibit an ability to satisfy performance metrics that reside in between other devices that might perform differently. As described above, in some examples a device performance metric (e.g., cycles per second, operations per second, bandwidth per unit of time, frequency, energy consumed per unit of time, etc.) may designate a label or type of device as being “power-saving,” “high performance,” or some intermediary designation. As such, the example normal group node 204 includes “Core 1,” “Core 5,” “Core 9,” and “Core 13.”

The example power-saving grouping 200 also includes a node weight value for each of the power-saving group node 202, the normal group node 204, and the high-performance group node 206. In particular, the power-saving group node 202 has a weight of zero (0), the normal group node 204 has a weight of two (2), and the high-performance group node 206 has a weight of four (4). The example group nodes within the power-saving grouping 200 also include an edge weight. In the illustrated example of FIG. 2, a first edge weight 208 has a value of one (1), a second edge weight 210 has a value of two (2), and a third edge weight 212 has a value of three (3). In operation, selecting one or more cores in the power-saving group node 202 has a cost of zero, selecting one or more cores in the normal group node 204 has a cost of two (2) (e.g., a penalty), and so on. However, if a prior selection has already been made for a workload in which the core was from the power-saving group node 202, but it is substituted for a core from the normal group node 204, then the cost (penalty) applied corresponds to the first edge weight 208 of one (1).

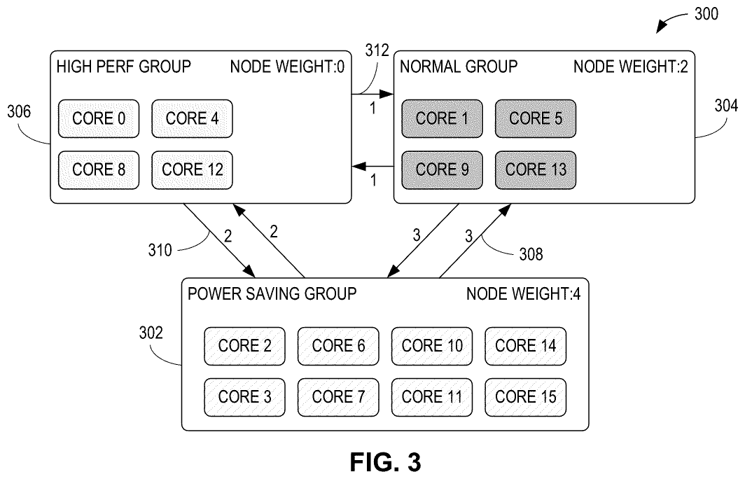

FIG. 3 is a block diagram of an example high-performance grouping 300. In some examples, the high-performance grouping 300 is generated as a data structure. In the illustrated example of FIG. 3, the high-performance grouping 300 includes a power-saving group node 302, a normal group node 304, and a high-performance group node 306. While the particular cores within each group node of FIG. 3 are the same as the cores within group nodes of FIG. 2, corresponding node weights and edge weight differ. Because the high-performance grouping 300 is generated to optimize objectives at achieving relatively high-performing operations, the power-saving group node 302 has a relatively highest weight of four (4) because it includes cores that are least capable of achieving high-performance operations. On the other hand, the high-performance group node 306 includes a weight of zero (0) because selecting resources from that group node are the best candidates to achieve a high-performance objective when executing a workload. Similar to the illustrated example of FIG. 2, the illustrated example of FIG. 3 includes a first edge weight 308, a second edge weight 310, and a third edge weight 312. If a prior selection has already been made for a workload in which the core was from the high-performance group node 306, but it is substituted for a core from the normal group node 304, then the corresponding cost (penalty) applied corresponds to the third edge weight 312.

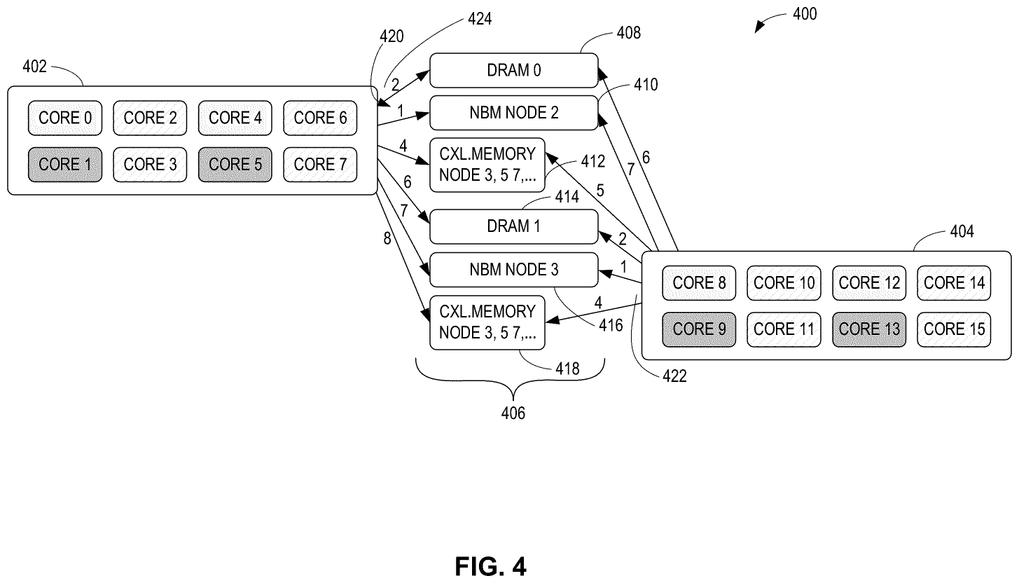

FIG. 4 is a block diagram of an example core-to-memory grouping 400. In some examples, workloads prefer a particular type of memory, such as HBM. In the illustrated example of FIG. 4, the core-to-memory grouping 400 includes a first sub-group of cores 402 and a second sub-group of cores 404. Respective ones of the cores within the first sub-group 402 and the second sub-group 404 are a particular distance from corresponding memory devices 406. The example memory devices 406 of FIG. 4 include a first DRAM 408, a first HBM node 410, a first CXL node 412, a second DRAM 414, a second HBM node 416, and a second CXL node 418.

As described above, when a core is paired with a memory device, the corresponding distance therebetween has an effect on latency metrics. As such, selecting particular devices to operate together has an effect on workload performance metrics. A relatively lowest-cost core-memory pair contains a particular core and its closest memory device. In the illustrated example of FIG. 4, Core 0 and the first HBM node 410 have a relatively close proximity to each other, which is represented by a first link score 420 of one (1). Similarly, Core 8 and the second HBM node 416 have a relatively close proximity to each other, which is represented by a second link score 422 of one (1). Selecting either of the above combinations results in a relatively best memory bandwidth.

In some examples, the relatively best selections may not be available for assignment to one or more workloads. As such, examples disclosed herein generate the example core-to-memory grouping 400 in a manner that illustrates alternate link scores so that next-best selections can be determined. In the illustrated example of FIG. 4, a third link score 424 having a value of two (2) indicates that a pairing between a core from the first sub-group of cores 402 and the first DRAM 408 is the next-best selection.

While the illustrated examples of FIGS. 1-4 include a particular number of cores, a particular number of memory devices, and a particular number of group nodes having particular performance capabilities, such examples are not limiting. Any number of additional and/or alternate group nodes may be considered herein without limitation.

As described above, some workloads include explicitly stated performance preferences and/or expectations. Performance preferences and/or expectations include, but are not limited to particular high-performance CPU cores, particular cache memory structures, particular memory bandwidth performance metrics, etc. In some examples, the workload performance preferences are retrieved, received and/or otherwise obtained from workload metadata, while in some examples default preferences are applied. In some examples, preferences seek to reduce remote memory accesses occurrences by keeping workload processes running in a same/similar memory zone that is closest (e.g., in proximity) to corresponding CPU cores. Such approaches may reduce overhead in memory access instances and reduce traffic between memory zones, which leave more bandwidth for those workloads that might need it.

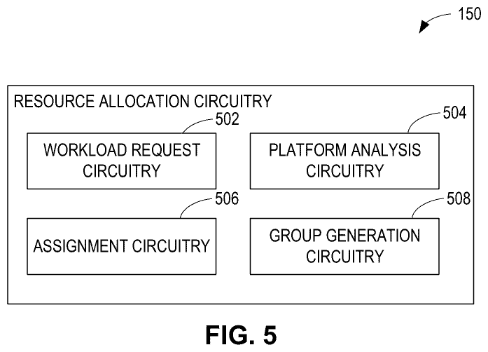

FIG. 5 is a block diagram of an example implementation of the resource allocation circuitry 150 of FIG. 1 to do resource allocation based on workload parameters. The resource allocation circuitry 150 of FIG. 5 may be instantiated (e.g., creating an instance of, bring into being for any length of time, materialize, implement, etc.) by programmable circuitry such as a Central Processor Unit (CPU) executing first instructions. Additionally or alternatively, the resource allocation circuitry 150 of FIG. 5 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 5 may, thus, be instantiated at the same or different times. Some or all of the circuitry of FIG. 5 may be instantiated, for example, in one or more threads executing concurrently on hardware and/or in series on hardware. Moreover, in some examples, some or all of the circuitry of FIG. 5 may be implemented by microprocessor circuitry executing instructions and/or FPGA circuitry performing operations to implement one or more virtual machines and/or containers.

In the illustrated example of FIG. 5, the resource allocation circuitry 150 includes example workload request circuitry 502, example platform analysis circuitry 504, example assignment circuitry 506, and example group generation circuitry 508. In operation, the example workload request circuitry 502 determines whether a workload request is available for analysis and, if so, retrieves one or more resource requirements (ResReqs) corresponding to the workload. Resource requirements include, but are not limited to a number of processors that the workload expects to have available during execution. For example, some workloads include code that optimizes execution with a particular number of processing resources that operate in a parallel manner. In some examples, resource requirements include a particular number of cores, a particular number of processors (CPUs), a particular number and/or type of processor (e.g., GPUs), etc.

Based on the quantity and/or type of resources preferred by the workload, the example platform analysis circuitry 504 retrieves information associated with available resources (ResAvail). In some examples, the resource allocation circuitry 150 is communicatively connected to one or more platforms, computers, servers, SoCs, etc. and performs a discovery analysis to determine available resources. In some examples, the platform analysis circuitry 504 generates the example hardware topology 100 as shown in FIG. 1 that is unique to the particular platform devices thereon.

Based on the information retrieved and/or otherwise obtained from the platform analysis circuitry 504 regarding available devices, the platform analysis circuitry 504 characterizes all devices to determine capability metrics, as described above. In some examples, device capability metrics include a “high-performance” metric associated with devices that satisfy a first performance threshold (e.g., a device operating frequency, a device bandwidth, etc.), a “power-saving” metric associated with devices that satisfy a second performance threshold, and a “normal” metric associated with devices that satisfy operating metrics residing therebetween.

In view of the characterized devices, the platform analysis circuitry 504 generates different connected groupings. Each one of the connected groupings is derived from the same set of characterized devices, but weights associated with the characterized devices differ based on target performance objectives. As described above, a first performance objective may be “power saving,” a second performance objective may be “high” (e.g., a high-performance objective), and a third performance objective may be “normal,” which is indicative of performance expectations between one or more extremes.

The example platform analysis circuitry 504 determines if the available resources (ResAvail) discovered on the platform satisfy the required resources expected by the workload (ResReqs). For example, the required resources expected by the workload may include a quantity of six (6) cores, and the platform may have ten (10) cores. At that level of analysis, the platform satisfies the quantity of needed resources, but examples disclosed herein also verify that such available resources also satisfy a resource type (e.g., high-performance cores versus low power cores). The example workload request circuitry 506 determines if there are one or more groupings to consider, such as a power-saving grouping or a high-performance grouping as described above. If so, the example assignment circuitry 506 selects a lowest-cost resource from the grouping of interest and updates a list of remaining resources available to the platform (so that future searches for platform resources provide an accurate count of availability). The example assignment circuitry 506 determines whether one or more additional resources are still needed for a workload request and continues to select those that are available.

However, if the available resources on a platform do not satisfy the requested resources associated with the workload (e.g., all platform resources are currently servicing one or more other workloads), then the assignment circuitry 506 may output an empty set of resources for tracking purposes to indicate that the workload does not have a requisite assortment to begin execution. While the previous selection of resources was from the grouping of interest (e.g., a power-saving grouping) and that grouping of interest has no further available resources (e.g., all power-saving cores are unavailable), then the example assignment circuitry 506 determines whether to consider next-best resources based on cost values. In some examples, the process stops or waits for the preferred resource types to become available, which may occur with workloads that do not accommodate for any flexibility. For instance, a resource intensive workload to convolve pixels may require high-performance cores, but will not consider anything relatively less-capable so that consumers of the workload are not frustrated by sub-par performance artifacts (e.g., screen stuttering, slow rendering, etc.). In some examples, the process waits for a finite amount of time so that the desired and/or otherwise preferred resource types become available.

When all required resources have been selected, considering that the lowest cost resources are selected first before considering alternate resources having a relatively higher cost (penalty) value, then the assignment circuitry 506 assigns those selected resources to the workload.

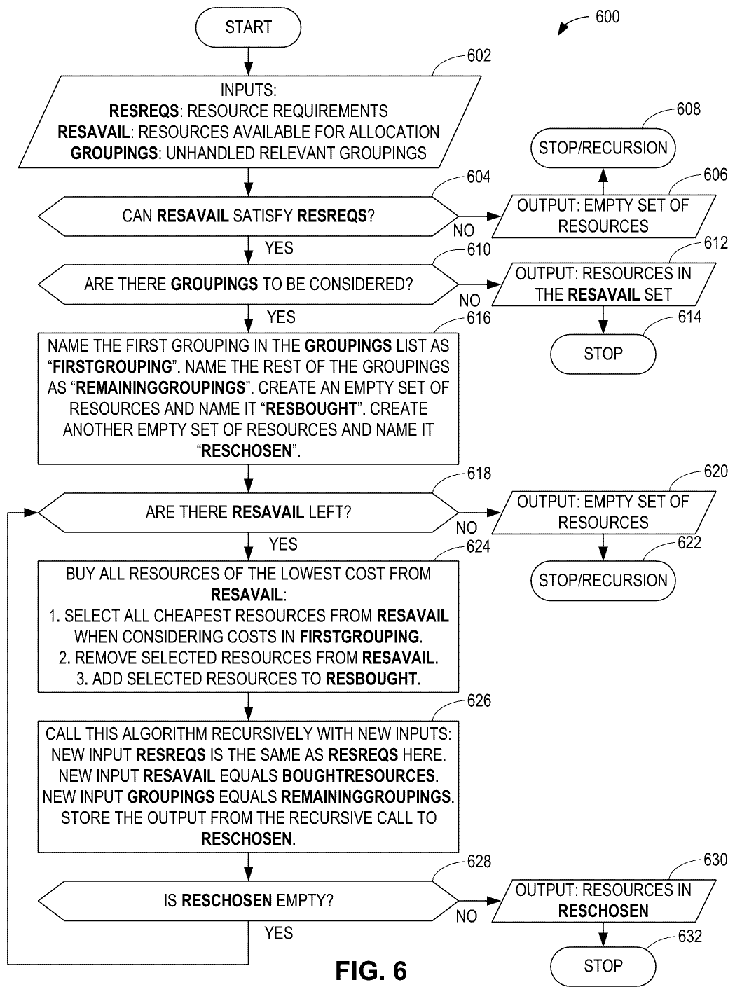

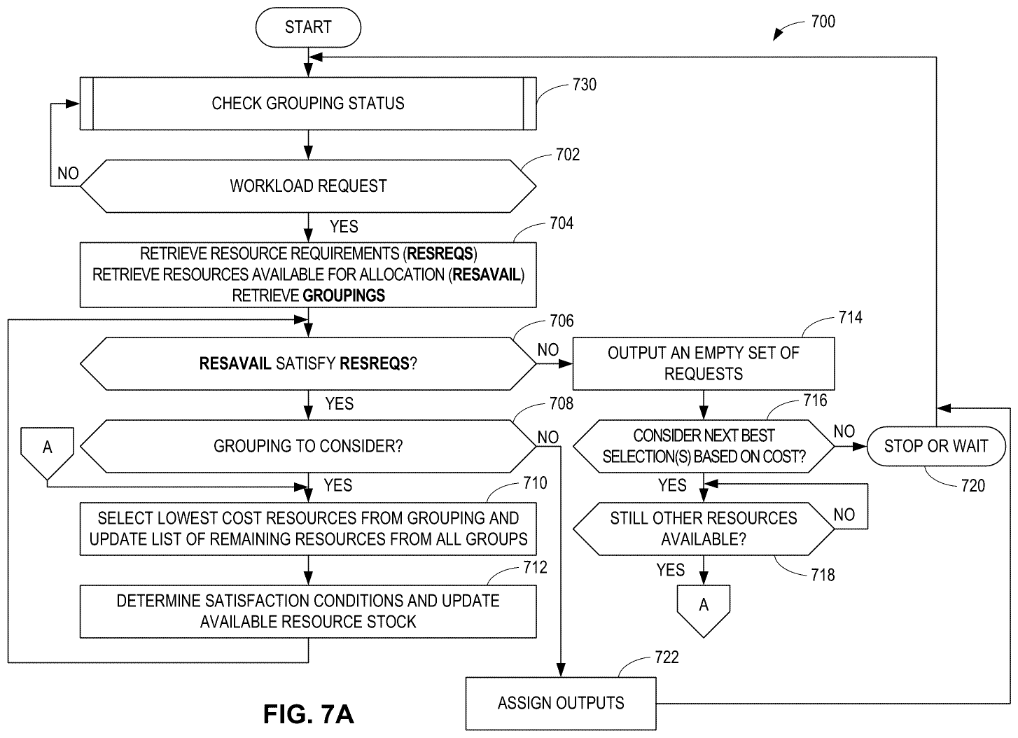

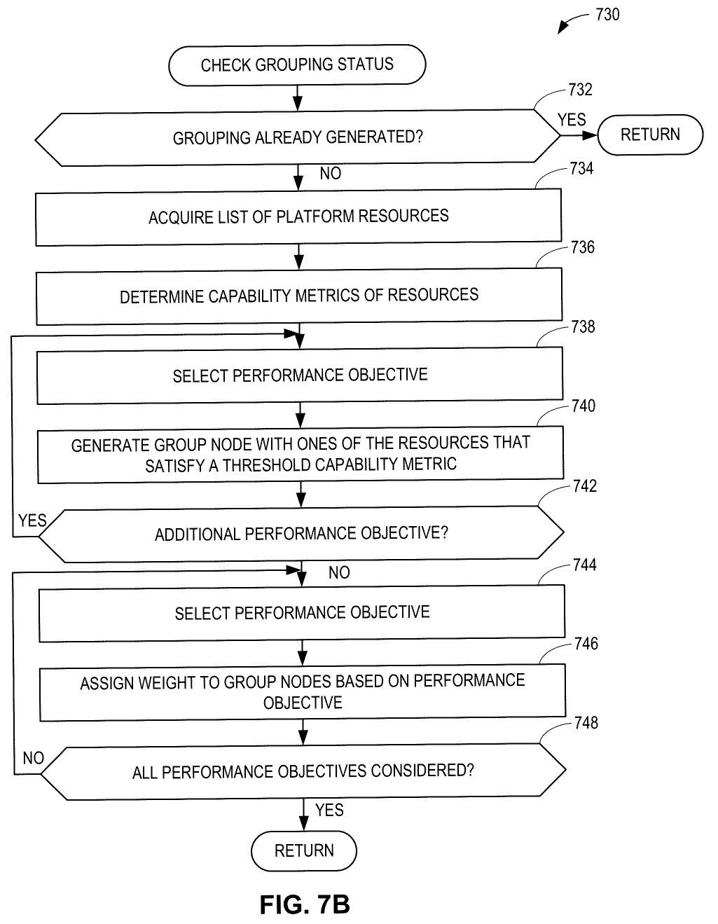

In some examples, the resource allocation circuitry 150 is instantiated by programmable circuitry executing resource allocation instructions and/or configured to perform operations such as those represented by the flowchart(s) of FIGS. 6 and 7. In some examples, the workload request circuitry 502 is instantiated by programmable circuitry executing workload request instructions and/or configured to perform operations such as those represented by the flowchart(s) of FIGS. 6, 7A and 7B. In some examples, the platform analysis circuitry 504 is instantiated by programmable circuitry executing platform analysis instructions and/or configured to perform operations such as those represented by the flowchart(s) of FIGS. 6, 7A and 7B. In some examples, the assignment circuitry 506 is instantiated by programmable circuitry executing assignment instructions and/or configured to perform operations such as those represented by the flowchart(s) of FIGS. 6, 7A and 7B.

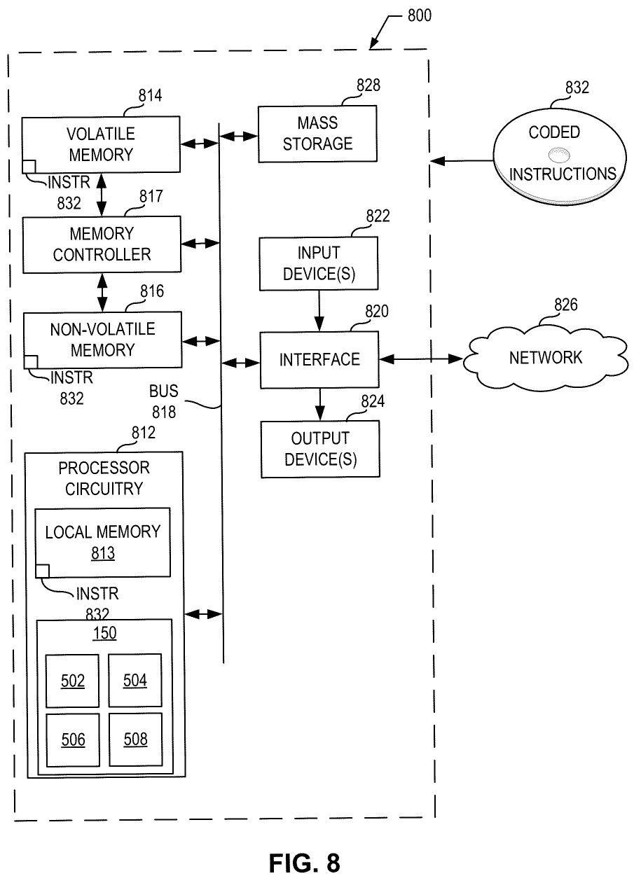

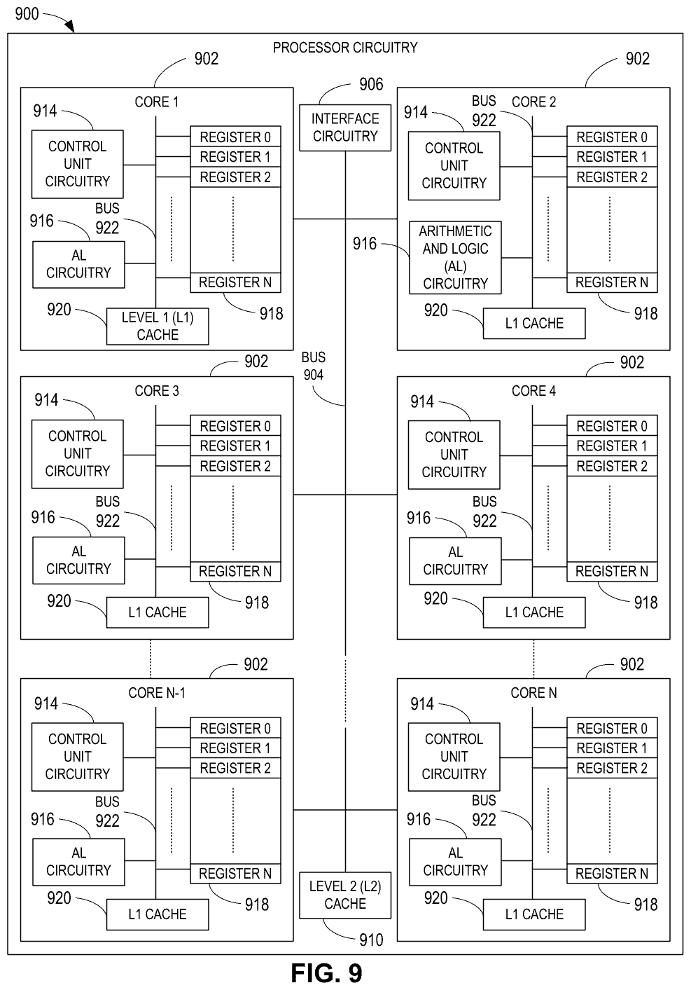

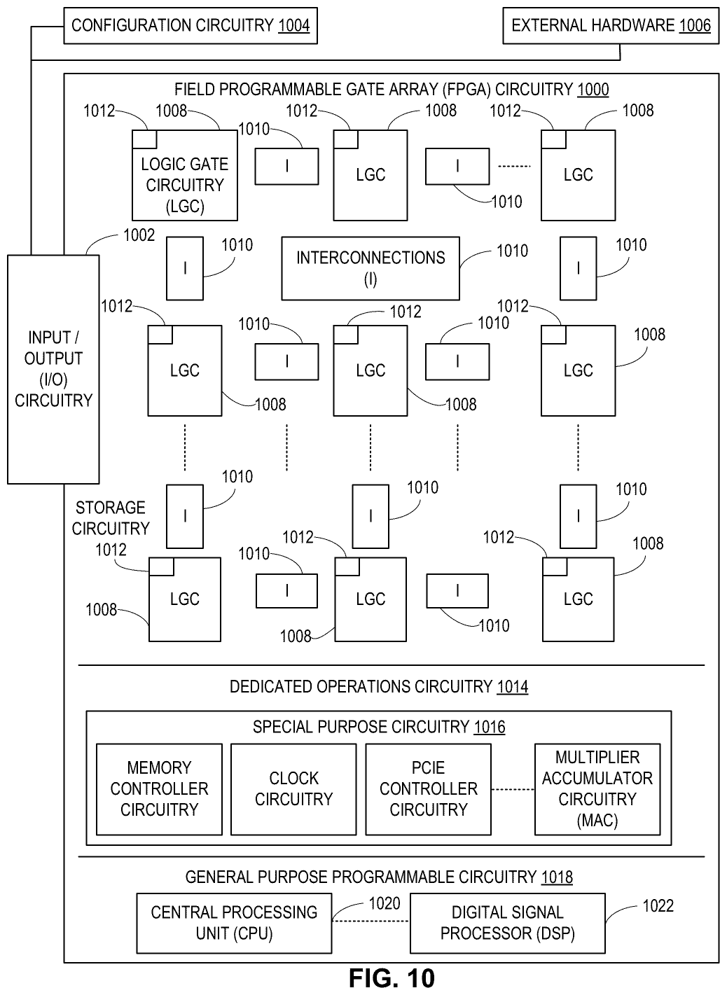

In some examples, the resource allocation circuitry 150 includes means for workload request. For example, the means for workload request may be implemented by workload request circuitry 502. In some examples, the resource allocation circuitry 150 includes means for platform analysis. For example, the means for platform analysis may be implemented by platform analysis circuitry 504. In some examples, the resource allocation circuitry 150 includes means for assignment. For example, the means for assignment may be implemented by assignment circuitry 506. In some examples, the resource allocation circuitry 150 includes means for group generation. For example, the means for group generation may be implemented by group generation circuitry 508. In some examples, the workload request circuitry 502, the platform analysis circuitry 504, the assignment circuitry 506, and/or the group generation circuitry 508 may be instantiated by programmable circuitry such as the example programmable circuitry 812 of FIG. 8. For instance, the aforementioned circuitry may be instantiated by the example microprocessor 900 of FIG. 9 executing machine executable instructions such as those implemented by at least blocks of FIGS. 6 and/or 7. In some examples, the aforementioned circuitry may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the aforementioned circuitry may be instantiated by any other combination of hardware, software, and/or firmware. For example, the aforementioned circuitry may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the resource allocation circuitry 150 of FIG. 1 is illustrated in FIG. 5, one or more of the elements, processes, and/or devices illustrated in FIG. 5 may be combined, divided, re-arranged, omitted, eliminated, and/or implemented in any other way. Further, the example workload request circuitry 502, the example platform analysis circuitry 504, the example assignment circuitry 506, the example group generation circuitry 508, and/or, more generally, the example resource allocation circuitry 150 of FIG. 5, may be implemented by hardware alone or by hardware in combination with software and/or firmware. Thus, for example, any of the example workload request circuitry 502, the example platform analysis circuitry 504, the example assignment circuitry 506, and/or, more generally, the example resource allocation circuitry 150, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example resource allocation circuitry 150 of FIG. 5 may include one or more elements, processes, and/or devices in addition to, or instead of, those illustrated in FIG. 5, and/or may include more than one of any or all of the illustrated elements, processes and devices.

Flowchart(s) representative of example machine readable instructions, which may be executed by programmable circuitry to implement and/or instantiate the resource allocation circuitry 150 of FIG. 5 and/or representative of example operations which may be performed by programmable circuitry to implement and/or instantiate the resource allocation circuitry 150 of FIG. 5, are shown in FIGS. 6, 7A and 7B. The machine readable instructions may be one or more executable programs or portion(s) of one or more executable programs for execution by programmable circuitry such as the programmable circuitry 812 shown in the example processor platform 800 discussed below in connection with FIG. 8 and/or may be one or more function(s) or portion(s) of functions to be performed by the example programmable circuitry (e.g., an FPGA) discussed below in connection with FIGS. 9 and/or 10. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 6, 7A and 7B, many other methods of implementing the example resource allocation circuitry 150 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 6, 7A and 7B may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 6 is a flowchart representative of example machine readable instructions and/or example operations 600 that may be executed, instantiated, and/or performed by programmable circuitry to allocate resources based on workload parameters. The example machine-readable instructions and/or the example operations 600 of FIG. 6 begin at block 602, at which the example platform analysis circuitry 504 generates one or more input data structures associated with resource requirements (ResReqs), resources available (e.g., on a platform) for allocation (ResAvail), and connected groupings. In some examples, if candidate connected groupings have not yet been generated for a platform of interest, the example group generation circuitry 508 creates one or more connected groupings based on (a) the available resources of the platform of interest and (b) a performance objective. As described above, a performance objective may include “power-saving” in which particular groups of resources (e.g., cores) include a weight value (cost) based on their ability to meet performance metrics associated with the performance objective (e.g., a core ability to consume a particular threshold energy value during a computing cycle).

The example platform analysis circuitry 504 determines whether the resources determined to be available on the platform (ResAvail) satisfy the resources requested and/or otherwise required by the workload (ResReqs) (block 604). If not, then the example resource allocation circuitry 150 outputs an empty set of resources as an indication that there is no solution for the resource allocation effort(s) (block 606), and the example process 600 stops (block 608), or the example process 600 performs a recursion in view of, for instance, a relatively larger set of resources (block 608). However, in some examples, the process 600 pauses instead of stops in an effort to determine if additional time results in one or more resources becoming available (e.g., a larger set of resources).

If the platform analysis circuitry 504 determines that the available resources satisfy the required resources (block 604), then the example workload request circuitry 502 determines if there are any groupings to be considered (block 610). If not, then the resource allocation circuitry 150 allocates those resources that may be available for the workload absent consideration of a specific connected grouping (block 612). On the other hand, if there is at least one connected grouping to be considered (block 610), then the example resource allocation circuitry 150 assigns and/or otherwise names the first grouping of interest as “FirstGrouping” with any remaining groupings of interest named as “RemainingGroupings” (block 616). In particular, while any number of connected groupings may have been generated for future use, if a workload has no particular interest in such groupings, they will not be included in any list of groupings of the example process 600 of FIG. 6. In some examples, no groupings are identified as preferred by the workload, in which case the process may end or perform a recursion at block 608 or block 614 because all resources are equally suitable for the workload. In some examples, two or more groupings are requested and/or otherwise identified by the workload. In such cases, the order in which those groupings is listed matters in the resource selection process. An earlier one of two or more groupings will cause selection of resources from that earlier grouping node, after which resources are selected from the subsequent grouping. Additionally, the example resource allocation circuitry 150 creates an empty set (e.g., a data structure) to store one or more resources that may be selected and/or otherwise “bought,” which is named “ResBought.” The example resource allocation circuitry 150 creates a data set to track which resources have been chosen as “ResChosen,” as described in further detail below.

The example workload request circuitry 502 determines whether there are available resources left from which to make selections for allocation to a workload (block 618). If not, then the example resource allocation circuitry 150 presents and/or otherwise outputs an empty set of resources (block 620) and the process 600 ends or performs a recursion in view of, for instance, a relatively larger set of resources (block 622). On the other hand, if resources remain available (block 618), then the assignment circuitry 506 selects resources having a relatively lowest cost value from the list of available resources from which to choose (ResAvail) that also belong to the connected grouping of interest (block 624). The assignment circuitry 506 also updates the list of remaining available resources so that they are not an option for future selection. Because one or more additional resources may still need to be selected to satisfy a list of resource requirements (ResReqs) for the workload, the assignment circuitry calls the process 600 again for a recursive analysis (block 626) and updates one or more lists to track which resources have been selected and which resources remain unavailable for selection. For instance, if the resource allocation circuitry 150 determines that a list corresponding to chosen resources is not empty (ResChosen) (block 628), the process 600 returns to block 618, otherwise those resources are output for allocation (block 630) before the process 600 stops (block 632).

To illustrate the example process 600 of FIG. 6 in view of a workload request scenario, consider a first workload that is already running (executing) and has eight (8) cores (note examples refer to cores, but any other type of resource may be considered, such as CPUs), such as Core 0 through Core 7. Consider a second workload request that includes accompanying information (e.g., metadata) identifying a need for six (6) cores and a power-saving grouping. As such, the resource requirements (ResReqs) are “at least 6 cores,” the available resources (ResAvail) are Core 8 through Core 15 (because Core 0 through Core 7 were previously allocated to the first workload), and the connected groupings identify “power-save” (block 602). Because the available resources include eight (8) cores, this satisfies the resource requirements for the second workload (block 604). Worth noting, however, is that the granularity of analysis at this stage of the process 600 observes raw resources available regardless of their performance type (e.g., high-performance, normal, power-save, etc.).

The example workload request circuitry 502 determines that there are connected groupings to be considered because at this stage of the process 600 there have not been any selections from the “power-saving” grouping (block 610). Stated differently, the previously generated “power-saving” connected grouping is unhandled. The resource allocation circuitry 150 associates the first grouping (FirstGrouping) as “power-save”, and generates an empty list for any other remaining groupings (RemainingGroupings) because they are not part of the workload request (despite the fact that any number of connected groupings were previously generated). In view of the recursive behavior of the example process 600, the workload request circuitry 502 verifies whether there are resources available from which to choose (block 618). Because the process 600 of FIG. 6 has not yet advanced through any selection process to satisfy the needs of the second workload, there are still resources left in this example.

The example assignment circuitry 506 “buys” and/or otherwise selects relatively cheapest (e.g., relatively lowest cost weight value) resources from the available resources list (ResAvail) in view of the cost weight values from the power-saving connected grouping (block 624). Briefly returning to the illustrated example of FIG. 2, Core 0 through Core 7 are not available, which leaves Core 10, Core 11, Core 14 and Core 15 from the power-saving group node 202. The assignment circuitry 506 selects these four (4) available cores from the power-saving group node 202, but that still leaves a need for two (2) more cores to satisfy the workload request of six cores. Stated differently, during this initial recursion of the process 600 only four (4) of the six (6) resources have been successfully allocated to the workload, and the assignment circuitry 506 calls the process 600 again with updated/new inputs (block 626). In particular, the assignment circuitry 506 identifies an updated list of available resources (ResAvail) as including Core 8, Core 9, Core 12 and Core 13. Control then returns to block 604.

The platform analysis circuitry 504 determines that the available resources (ResAvail) does not satisfy the required resources (ResReqs) because now only four (4) of the required six (6) resources are available for selection (e.g., “purchase”) (block 604). The resource allocation circuitry 150 generates an empty set of resources (ResChosen=empty) to indicate that the current conditions of the platform are insufficient to satisfy the workload request (block 606), and control reverts back to the recursion branch of block 628. Because ResChosen is empty (block 628), which illustrates that resource selection with the current criteria has failed, control returns to block 618 to determine whether there are still resources available (ResAvail).

In this recursive stage of the process 600, there are still four (4) cores available, as described above. However, none of those available cores are associated with the desired “power-saving” grouping node. In particular, the remaining resources now include Core 8 and Core 12 (from the high-performance grouping node 206), and Core 9 and Core 13 (from the normal grouping node 204). The assignment circuitry 506 buys the relatively cheapest ones of the available resources, which include Core 9 and Core 13 because their associated cost has a weight of two (2) as compared to Core 8 and Core 12 that have a relatively higher cost of four (4) (block 624). The assignment circuitry 506 again executes a recursive call for the process 600 with inputs that reflect the updated available resources (ResAvail) to include six (6) cores of Core 10, Core 11, Core 14, Core 15, and newly added Core 9 and Core 13 (block 602). The platform analysis circuitry 504 determines that the available resources satisfy the requested resources (block 604), and the workload request circuitry 502 determines that there are no further connected groupings to consider (block 610) because the previous recursion analyzed the “power-saving” request. The resource allocation circuitry 150 outputs the set of available resources (ResAvail) (block 612), and the process returns to the recursion branch at block 628. Because the chosen resources (ResChosen) is not empty (block 628) and includes Core 10, Core 11, Core 14, Core 15, Core 9 and Core 13 to be output as the resources for the second workload (block 630).

FIG. 7A is a flowchart representative of alternate example machine readable instructions and/or example operations 700 that may be executed, instantiated, and/or performed by programmable circuitry to allocate resources based on workload parameters. The example machine-readable instructions and/or the example operations 700 of FIG. 7A begin at block 730, at which the example group generation circuitry 508 determines whether one or more connected groupings have been generated, as described further in connection with FIG. 7B. The example workload request circuitry 502 determines if a workload request has occurred (block 702) and if not, the example operations 700 wait for such an occurrence. Otherwise, in response to a workload request the example platform analysis circuitry 504 generates or retrieves one or more input data structures associated with resource requirements (ResReqs), resources available (e.g., on a platform) for allocation (ResAvail), and connected groupings (block 704). The example platform analysis circuitry 504 determines whether the resources determined to be available on the platform (ResAvail) satisfy the resources requested and/or otherwise required by the workload (ResReqs) (block 706). If not, then the example assignment circuitry 506 outputs an empty set of resources as an indication that further analysis of the resources may be needed to find a solution to the workload request (block 714). The assignment circuitry 506 determines whether to consider a next-best selection of resources based on a cost metric (block 716). If not, then the example operations 700 stop (block 720) or wait for a period of time for the possibility that one or more needed resources will become available (e.g., one or more resources that are later relinquished after completing one or more prior workload requests).

If the assignment circuitry 506 determines that next-best considerations should be attempted (block 716), the platform analysis circuitry 504 determines whether other resources are still available, even though they might not align with a grouping of interest (block 718). If so, the operations 700 advance to block 710, as described in further detail below. Briefly returning to block 706, if the available resources satisfy the required resources, then the workload request circuitry 502 determines whether there is a grouping to consider (block 708). If not, then the assignment circuitry 506 assigns resource outputs that may be available without regard to performance target objectives (block 722). On the other hand, when a grouping of interest is to be considered (block 708), then the assignment circuitry 506 selects lowest cost resources from the grouping of interest and updates a list of the remaining resources that the platform could use for the workload (block 710). As described above, a grouping of interest specifies particular resource combinations that align with and/or otherwise promote a performance objective requested by the workload. Example performance objectives include, but are not limited to power-saving performance objectives, high-performance objectives, etc. The assignment circuitry 506 determines satisfaction conditions for the workload, such as determining whether all conditions have been satisfied (e.g., did the workload receive a complete quantity of resources that were requested and of the correct type) and updates lists associated with remaining resource stock/availability (block 712).

The platform analysis circuitry 504 again analyzes the circumstances after the assignment effort to determine if the available resources now satisfy the requested resources (block 706). In this example, consider that the available resources satisfy the requested resources, and that there are no further groupings to consider (block 708). The example operations 700 now include a list of resources that either align with workload requests, or include the next best resource selections that reduce and/or otherwise minimize deviation from a workload performance objective. Such resources are assigned as outputs so that the workload can begin execution in view of the selected resources (block 722).

FIG. 7B is a flowchart including additional details corresponding to checking grouping status (block 730). In the illustrated example of FIG. 7B, the group generation circuitry 508 determines whether one or more groupings have already been generated (block 732). If so, then the operations 730 return to avoid redundant effort(s). On the other hand, if a platform has not yet had one or more groupings generated (block 732) (e.g., a new platform that has not yet been analyzed), then the example platform analysis circuitry 504 acquires a list of platform resources (block 734), such as a hardware discovery task(s). Stated differently, the example platform analysis circuitry 504 performs an inventory of an available platform from which resources can be selected for workloads.

For each of the resources detected, the example platform analysis circuitry 504 determines capability metrics (block 736). For instance, while a platform may have any number of CPUs, GPUs, cores, memory, etc., such resources may not have the same capabilities. Examples disclosed herein overcome previous efforts to assign resources to a workload in a manner that avoids resource waste by over-provisioning some resources that are more capable than necessary, or under-provisioning some resources that are not capable of satisfying performance objectives of the workload(s).

The example group generation circuitry 508 selects a performance objective of interest (block 738). As described above, an example performance objective may include “power-saving” so that workload execution occurs in a manner that utilizes as little energy as possible. Such performance objectives may be particularly helpful for mobile devices having limited on-board power supplies. In some examples, a “high-performance” objective may be requested by a workload, in which performance metrics are of a primary concern (e.g., speed, low latency, etc.). The group generation circuitry 508 generates a group node with ones of the resources that satisfy a threshold capability metric (block 740). For instance, resources that exhibit the relatively lowest energy consumption metrics per unit of time may be grouped into a node, such as the example power-saving group node 202 of FIG. 2. The group generation circuitry 508 determines whether there are one or more additional performance objectives to consider (block 742), and the operations 730 return to block 738 in such circumstances.

After all resources have been placed in corresponding groups based on their respective capabilities, the example group generation circuitry 508 selects one of those performance objectives (block 744), such as the power-saving performance objective. The group generation circuitry 508 assigns weights to each group node based on that selected performance objective, in which groups that deviate from the performance objective are assigned relatively higher weights (e.g., penalties, costs) (block 746). The group generation circuitry 508 determines whether all performance objectives have been considered so that all group nodes are assigned a relevant weight corresponding to that performance objective (block 748). If not, the operations 730 return to block 744, otherwise the operations return to block 702 of FIG. 7A.

FIG. 8 is a block diagram of an example programmable circuitry platform 800 structured to execute and/or instantiate the example machine-readable instructions and/or the example operations of FIGS. 6, 7A and 7B to implement the resource allocation circuitry 150 of FIG. 5. The programmable circuitry platform 800 can be, for example, a server, a personal computer, a workstation, a self-learning machine (e.g., a neural network), a mobile device (e.g., a cell phone, a smart phone, a tablet such as an iPad™), an Internet appliance, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 800 of the illustrated example includes programmable circuitry 812. The programmable circuitry 812 of the illustrated example is hardware. For example, the programmable circuitry 812 can be implemented by one or more integrated circuits, logic circuits, FPGAs, microprocessors, CPUs, GPUs, DSPs, and/or microcontrollers from any desired family or manufacturer. The programmable circuitry 812 may be implemented by one or more semiconductor based (e.g., silicon based) devices. In this example, the programmable circuitry 812 implements the example workload request circuitry 502, the example platform analysis circuitry 504, the example assignment circuitry 506, the example group generation circuitry 508, and the example resource allocation circuitry.

The programmable circuitry 812 of the illustrated example includes a local memory 813 (e.g., a cache, registers, etc.). The programmable circuitry 812 of the illustrated example is in communication with main memory 814, 816, which includes a volatile memory 814 and a non-volatile memory 816, by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller 817. In some examples, the memory controller 817 may be implemented by one or more integrated circuits, logic circuits, microcontrollers from any desired family or manufacturer, or any other type of circuitry to manage the flow of data going to and from the main memory 814, 816.

The programmable circuitry platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 822 are connected to the interface circuitry 820. The input device(s) 822 permit(s) a user (e.g., a human user, a machine user, etc.) to enter data and/or commands into the programmable circuitry 812. The input device(s) 822 can be implemented by, for example, an audio sensor, a microphone, a camera (still or video), a keyboard, a button, a mouse, a touchscreen, a trackpad, a trackball, an isopoint device, and/or a voice recognition system.

One or more output devices 824 are also connected to the interface circuitry 820 of the illustrated example. The output device(s) 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 800 of the illustrated example also includes one or more mass storage discs or devices 828 to store firmware, software, and/or data. Examples of such mass storage discs or devices 828 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 832, which may be implemented by the machine readable instructions of FIGS. 6, 7A and 7B, may be stored in the mass storage device 828, in the volatile memory 814, in the non-volatile memory 816, and/or on at least one non-transitory computer readable storage medium such as a CD or DVD which may be removable.

FIG. 9 is a block diagram of an example implementation of the programmable circuitry 812 of FIG. 8. In this example, the programmable circuitry 812 of FIG. 8 is implemented by a microprocessor 900. For example, the microprocessor 900 may be a general-purpose microprocessor (e.g., general-purpose microprocessor circuitry). The microprocessor 900 executes some or all of the machine-readable instructions of the flowcharts of FIGS. 6, 7A and 7B to effectively instantiate the circuitry of FIG. 2 as logic circuits to perform operations corresponding to those machine readable instructions. In some such examples, the circuitry of FIG. 5 is instantiated by the hardware circuits of the microprocessor 900 in combination with the machine-readable instructions. For example, the microprocessor 900 may be implemented by multi-core hardware circuitry such as a CPU, a DSP, a GPU, an XPU, etc. Although it may include any number of example cores 902 (e.g., 1 core), the microprocessor 900 of this example is a multi-core semiconductor device including N cores. The cores 902 of the microprocessor 900 may operate independently or may cooperate to execute machine readable instructions. For example, machine code corresponding to a firmware program, an embedded software program, or a software program may be executed by one of the cores 902 or may be executed by multiple ones of the cores 902 at the same or different times. In some examples, the machine code corresponding to the firmware program, the embedded software program, or the software program is split into threads and executed in parallel by two or more of the cores 902. The software program may correspond to a portion or all of the machine readable instructions and/or operations represented by the flowcharts of FIGS. 6, 7A and 7B.

The cores 902 may communicate by a first example bus 904. In some examples, the first bus 904 may be implemented by a communication bus to effectuate communication associated with one(s) of the cores 902. For example, the first bus 904 may be implemented by at least one of an Inter-Integrated Circuit (I2C) bus, a Serial Peripheral Interface (SPI) bus, a PCI bus, or a PCIe bus. Additionally or alternatively, the first bus 904 may be implemented by any other type of computing or electrical bus. The cores 902 may obtain data, instructions, and/or signals from one or more external devices by example interface circuitry 906. The cores 902 may output data, instructions, and/or signals to the one or more external devices by the interface circuitry 906. Although the cores 902 of this example include example local memory 920 (e.g., Level 1 (L1) cache that may be split into an L1 data cache and an L1 instruction cache), the microprocessor 900 also includes example shared memory 910 that may be shared by the cores (e.g., Level 2 (L2 cache)) for high-speed access to data and/or instructions. Data and/or instructions may be transferred (e.g., shared) by writing to and/or reading from the shared memory 910. The local memory 920 of each of the cores 902 and the shared memory 910 may be part of a hierarchy of storage devices including multiple levels of cache memory and the main memory (e.g., the main memory 814, 816 of FIG. 8). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 902 may be referred to as a CPU, DSP, GPU, etc., or any other type of hardware circuitry. Each core 902 includes control unit circuitry 914, arithmetic and logic (AL) circuitry (sometimes referred to as an ALU) 916, a plurality of registers 918, the local memory 920, and a second example bus 922. Other structures may be present. For example, each core 902 may include vector unit circuitry, single instruction multiple data (SIMD) unit circuitry, load/store unit (LSU) circuitry, branch/jump unit circuitry, floating-point unit (FPU) circuitry, etc. The control unit circuitry 914 includes semiconductor-based circuits structured to control (e.g., coordinate) data movement within the corresponding core 902. The AL circuitry 916 includes semiconductor-based circuits structured to perform one or more mathematic and/or logic operations on the data within the corresponding core 902. The AL circuitry 916 of some examples performs integer based operations. In other examples, the AL circuitry 916 also performs floating-point operations. In yet other examples, the AL circuitry 916 may include first AL circuitry that performs integer-based operations and second AL circuitry that performs floating-point operations. In some examples, the AL circuitry 916 may be referred to as an Arithmetic Logic Unit (ALU).

The registers 918 are semiconductor-based structures to store data and/or instructions such as results of one or more of the operations performed by the AL circuitry 916 of the corresponding core 902. For example, the registers 918 may include vector register(s), SIMD register(s), general-purpose register(s), flag register(s), segment register(s), machine-specific register(s), instruction pointer register(s), control register(s), debug register(s), memory management register(s), machine check register(s), etc. The registers 918 may be arranged in a bank as shown in FIG. 9. Alternatively, the registers 918 may be organized in any other arrangement, format, or structure, such as by being distributed throughout the core 902 to shorten access time. The second bus 922 may be implemented by at least one of an I2C bus, a SPI bus, a PCI bus, or a PCIe bus.

Each core 902 and/or, more generally, the microprocessor 900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 900 is a semiconductor device fabricated to include many transistors interconnected to implement the structures described above in one or more integrated circuits (ICs) contained in one or more packages.

The microprocessor 900 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 900, in the same chip package as the microprocessor 900 and/or in one or more separate packages from the microprocessor 900.

FIG. 10 is a block diagram of another example implementation of the programmable circuitry 812 of FIG. 8. In this example, the programmable circuitry 812 is implemented by FPGA circuitry 1000. For example, the FPGA circuitry 1000 may be implemented by an FPGA. The FPGA circuitry 1000 can be used, for example, to perform operations that could otherwise be performed by the example microprocessor 900 of FIG. 9 executing corresponding machine readable instructions. However, once configured, the FPGA circuitry 1000 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 900 of FIG. 9 described above (which is a general purpose device that may be programmed to execute some or all of the machine readable instructions represented by the flowchart(s) of FIGS. 6, 7A and 7B but whose interconnections and logic circuitry are fixed once fabricated), the FPGA circuitry 1000 of the example of FIG. 10 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 6, 7A and 7B. In particular, the FPGA circuitry 1000 may be thought of as an array of logic gates, interconnections, and switches. The switches can be programmed to change how the logic gates are interconnected by the interconnections, effectively forming one or more dedicated logic circuits (unless and until the FPGA circuitry 1000 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 6, 7A and 7B. As such, the FPGA circuitry 1000 may be configured and/or structured to effectively instantiate some or all of the operations/functions corresponding to the machine readable instructions of the flowchart(s) of FIGS. 6, 7A and 7B as dedicated logic circuits to perform the operations/functions corresponding to those software instructions in a dedicated manner analogous to an ASIC. Therefore, the FPGA circuitry 1000 may perform the operations/functions corresponding to the some or all of the machine readable instructions of FIGS. 6, 7A and 7B faster than the general-purpose microprocessor can execute the same.

In the example of FIG. 10, the FPGA circuitry 1000 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

The FPGA circuitry 1000 of FIG. 10, includes example input/output (I/O) circuitry 1002 to obtain and/or output data to/from example configuration circuitry 1004 and/or external hardware 1006. For example, the configuration circuitry 1004 may be implemented by interface circuitry that may obtain a binary file, which may be implemented by a bit stream, data, and/or machine-readable instructions, to configure the FPGA circuitry 1000, or portion(s) thereof. In some such examples, the configuration circuitry 1004 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1006 may be implemented by external hardware circuitry. For example, the external hardware 1006 may be implemented by the microprocessor 900 of FIG. 9.

The FPGA circuitry 1000 also includes an array of example logic gate circuitry 1008, a plurality of example configurable interconnections 1010, and example storage circuitry 1012. The logic gate circuitry 1008 and the configurable interconnections 1010 are configurable to instantiate one or more operations/functions that may correspond to at least some of the machine readable instructions of FIGS. 6, 7A and 7B and/or other desired operations. The logic gate circuitry 1008 shown in FIG. 10 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1008 to enable configuration of the electrical structures and/or the logic gates to form circuits to perform desired operations/functions. The logic gate circuitry 1008 may include other electrical structures such as look-up tables (LUTs), registers (e.g., flip-flops or latches), multiplexers, etc.

The configurable interconnections 1010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1008 to program desired logic circuits.

The storage circuitry 1012 of the illustrated example is structured to store result(s) of the one or more of the operations performed by corresponding logic gates. The storage circuitry 1012 may be implemented by registers or the like. In the illustrated example, the storage circuitry 1012 is distributed amongst the logic gate circuitry 1008 to facilitate access and increase execution speed.

The example FPGA circuitry 1000 of FIG. 10 also includes example dedicated operations circuitry 1014. In this example, the dedicated operations circuitry 1014 includes special purpose circuitry 1016 that may be invoked to implement commonly used functions to avoid the need to program those functions in the field. Examples of such special purpose circuitry 1016 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1000 may also include example general purpose programmable circuitry 1018 such as an example CPU 1020 and/or an example DSP 1022. Other general purpose programmable circuitry 1018 may additionally or alternatively be present such as a GPU, an XPU, etc., that can be programmed to perform other operations.

Although FIGS. 9 and 10 illustrate two example implementations of the programmable circuitry 812 of FIG. 8, many other approaches are contemplated. For example, FPGA circuitry may include an on-board CPU, such as one or more of the example CPU 1020 of FIG. 9. Therefore, the programmable circuitry 812 of FIG. 8 may additionally be implemented by combining at least the example microprocessor 900 of FIG. 9 and the example FPGA circuitry 1000 of FIG. 10. In some such hybrid examples, one or more cores 902 of FIG. 9 may execute a first portion of the machine readable instructions represented by the flowchart(s) of FIGS. 6, 7A and 7B to perform first operation(s)/function(s), the FPGA circuitry 1000 of FIG. 10 may be configured and/or structured to perform second operation(s)/function(s) corresponding to a second portion of the machine readable instructions represented by the flowcharts of FIGS. 6, 7A and 7B, and/or an ASIC may be configured and/or structured to perform third operation(s)/function(s) corresponding to a third portion of the machine readable instructions represented by the flowcharts of FIGS. 6, 7A and 7B.

It should be understood that some or all of the circuitry of FIG. 5 may, thus, be instantiated at the same or different times. For example, same and/or different portion(s) of the microprocessor 900 of FIG. 9 may be programmed to execute portion(s) of machine-readable instructions at the same and/or different times. In some examples, same and/or different portion(s) of the FPGA circuitry 1000 of FIG. 10 may be configured and/or structured to perform operations/functions corresponding to portion(s) of machine-readable instructions at the same and/or different times.

In some examples, some or all of the circuitry of FIG. 5 may be instantiated, for example, in one or more threads executing concurrently and/or in series. For example, the microprocessor 900 of FIG. 9 may execute machine readable instructions in one or more threads executing concurrently and/or in series. In some examples, the FPGA circuitry 1000 of FIG. 10 may be configured and/or structured to carry out operations/functions concurrently and/or in series. Moreover, in some examples, some or all of the circuitry of FIG. 5 may be implemented within one or more virtual machines and/or containers executing on the microprocessor 900 of FIG. 9.

In some examples, the programmable circuitry 812 of FIG. 8 may be in one or more packages. For example, the microprocessor 900 of FIG. 9 and/or the FPGA circuitry 1000 of FIG. 10 may be in one or more packages. In some examples, an XPU may be implemented by the programmable circuitry 812 of FIG. 8, which may be in one or more packages. For example, the XPU may include a CPU (e.g., the microprocessor 900 of FIG. 9, the CPU 1020 of FIG. 10, etc.) in one package, a DSP (e.g., the DSP 1022 of FIG. 10) in another package, a GPU in yet another package, and an FPGA (e.g., the FPGA circuitry 1000 of FIG. 10) in still yet another package.

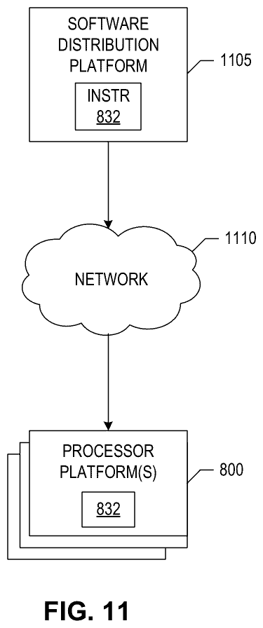

A block diagram illustrating an example software distribution platform 1105 to distribute software such as the example machine readable instructions 832 of FIG. 8 to other hardware devices (e.g., hardware devices owned and/or operated by third parties from the owner and/or operator of the software distribution platform) is illustrated in FIG. 11. The example software distribution platform 1105 may be implemented by any computer server, data facility, cloud service, etc., capable of storing and transmitting software to other computing devices. The third parties may be customers of the entity owning and/or operating the software distribution platform 1105. For example, the entity that owns and/or operates the software distribution platform 1105 may be a developer, a seller, and/or a licensor of software such as the example machine readable instructions 832 of FIG. 8. The third parties may be consumers, users, retailers, OEMs, etc., who purchase and/or license the software for use and/or re-sale and/or sub-licensing. In the illustrated example, the software distribution platform 1105 includes one or more servers and one or more storage devices. The storage devices store the machine readable instructions 832, which may correspond to the example machine readable instructions of FIGS. 6, 7A and 7B, as described above. The one or more servers of the example software distribution platform 1105 are in communication with an example network 1110, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 832 from the software distribution platform 1105. For example, the software, which may correspond to the example machine readable instructions of FIGS. 6, 7A and 7B, may be downloaded to the example programmable circuitry platform 800, which is to execute the machine readable instructions 832 to implement the resource allocation circuitry 150. In some examples, one or more servers of the software distribution platform 1105 periodically offer, transmit, and/or force updates to the software (e.g., the example machine readable instructions 832 of FIG. 8) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that improve efficiency results when assigning resources to workloads. Prior efforts to assign resources typically identify unassigned resources without regard to whether they are suitable for workload expectations. In the event assignments consider resource capabilities, prior efforts still fail to identify (a) relative cost values (penalties) for particular resources and/or (b) relative cost values (penalties) for next-best available resources when one or more preferred selections are unavailable. Disclosed systems, apparatus, articles of manufacture, and methods improve the efficiency of using a computing device by preventing wasteful resource assignment by virtue of resource availability alone. Disclosed systems, apparatus, articles of manufacture, and methods are accordingly directed to one or more improvement(s) in the operation of a machine such as a computer or other electronic and/or mechanical device.

Example methods, systems, articles of manufacture, and apparatus to allocate resources based on workload parameters are disclosed herein. Further examples and combinations thereof include the following:

Example 1 includes an apparatus comprising interface circuitry, machine-readable instructions, and at least one processor circuit to be programmed by the machine-readable instructions to generate groups of processor cores based on performance capability values, assign a first one of the groups a first computation cost value based on (a) first ones of the performance capability values and (b) a first computation performance objective associated with a workload, and assign a second one of the groups a second computation cost value based on (a) second ones of the performance capability values and (b) a second computation performance objective associated with the workload.

Example 2 includes the apparatus as defined in example 1, wherein the first computation performance objective is a power saving objective, one or more of the at least one processor circuit is to assign a first processor core to the workload from the first one of the groups based on the workload including the first computation performance objective.

Example 3 includes the apparatus as defined in example 2, wherein one or more of the at least one processor circuit is to assign the first processor core to the workload from the second one of the groups based on an availability status of ones of the processor cores in the first one of the groups.

Example 4 includes the apparatus as defined in example 3, wherein the availability status is at least one of unavailable or available after a threshold period of time.

Example 5 includes the apparatus as defined in example 2, wherein one or more of the at least one processor circuit is to assign a second processor core to the workload from the second one of the groups based on an availability status of ones of the processor cores in the first one of the groups.

Example 6 includes the apparatus as defined in example 1, wherein one or more of the at least one processor circuit is to assign first ones of the processor cores to the workload based on a lowest one of the first computation cost value or the second computation cost value.

Example 7 includes the apparatus as defined in example 6, wherein one or more of the at least one processor circuit is to assign second ones of the processor cores to the workload based on an unavailability status associated with the first ones of the processor cores.

Example 8 includes At least one non-transitory machine-readable medium comprising machine-readable instructions to cause at least one processor circuit to at least generate groups of processor cores based on performance capability values, assign a first one of the groups a first computation cost value based on (a) first ones of the performance capability values and (b) a first computation performance objective associated with a workload, and assign a second one of the groups a second computation cost value based on (a) second ones of the performance capability values and (b) a second computation performance objective associated with the workload.

Example 9 includes the at least one non-transitory machine-readable medium as defined in example 8, wherein the machine-readable instructions are to cause one or more of the at least one processor circuit to identify the first computation performance objective as a power saving objective, and assign a first processor core to the workload from the first one of the groups based on the workload including the first computation performance objective.

Example 10 includes the at least one non-transitory machine-readable medium as defined in example 9, wherein the machine-readable instructions are to cause one or more of the at least one processor circuit to assign the first processor core to the workload from the second one of the groups based on an availability status of ones of the processor cores in the first one of the groups.

Example 11 includes the at least one non-transitory machine-readable medium as defined in example 10, wherein the machine-readable instructions are to cause one or more of the at least one processor circuit to identify the availability status as at least one of unavailable or available after a threshold period of time.

Example 12 includes the at least one non-transitory machine-readable medium as defined in example 9, wherein the machine-readable instructions are to cause one or more of the at least one processor circuit to assign a second processor core to the workload from the second one of the groups based on an availability status of ones of the processor cores in the first one of the groups.

Example 13 includes the at least one non-transitory machine-readable medium as defined in example 8, wherein the machine-readable instructions are to cause one or more of the at least one processor circuit to assign first ones of the processor cores to the workload based on a lowest one of the first computation cost value or the second computation cost value.

Example 14 includes the at least one non-transitory machine-readable medium as defined in example 13, wherein the machine-readable instructions are to cause one or more of the at least one processor circuit to assign second ones of the processor cores to the workload based on an unavailability status associated with the first ones of the processor cores.

Example 15 includes a method comprising generating, by at least one processor circuit programmed by at least one instruction, groups of processor cores based on performance capability values, assign, by one or more of the at least one processor circuit, a first one of the groups a first computation cost value based on (a) first ones of the performance capability values and (b) a first computation performance objective associated with a workload, and assign, by one or more of the at least one processor circuit, a second one of the groups a second computation cost value based on (a) second ones of the performance capability values and (b) a second computation performance objective associated with the workload.

Example 16 includes the method as defined in example 15, further including identifying the first computation performance objective is a power saving objective, and assigning a first processor core to the workload from the first one of the groups based on the workload including the first computation performance objective.

Example 17 includes the method as defined in example 16, further including assigning the first processor core to the workload from the second one of the groups based on an availability status of ones of the processor cores in the first one of the groups.

Example 18 includes the method as defined in example 17, further including determining the availability status is at least one of unavailable or available after a threshold period of time.

Example 19 includes the method as defined in example 16, further including assigning a second processor core to the workload from the second one of the groups based on an availability status of ones of the processor cores in the first one of the groups.

Example 20 includes the method as defined in example 15, further including assigning first ones of the processor cores to the workload based on a lowest one of the first computation cost value or the second computation cost value.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry;
machine-readable instructions; and
at least one processor circuit to be programmed by the machine-readable instructions to:
generate groups of processor cores based on performance capability values;
assign a first one of the groups a first computation cost value based on (a) first ones of the performance capability values and (b) a first computation performance objective associated with a workload; and
assign a second one of the groups a second computation cost value based on (a) second ones of the performance capability values and (b) a second computation performance objective associated with the workload.

2. The apparatus as defined in claim 1, wherein the first computation performance objective is a power saving objective, one or more of the at least one processor circuit is to assign a first processor core to the workload from the first one of the groups based on the workload including the first computation performance objective.

3. The apparatus as defined in claim 2, wherein one or more of the at least one processor circuit is to assign the first processor core to the workload from the second one of the groups based on an availability status of ones of the processor cores in the first one of the groups.

4. The apparatus as defined in claim 3, wherein the availability status is at least one of unavailable or available after a threshold period of time.

5. The apparatus as defined in claim 2, wherein one or more of the at least one processor circuit is to assign a second processor core to the workload from the second one of the groups based on an availability status of ones of the processor cores in the first one of the groups.

6. The apparatus as defined in claim 1, wherein one or more of the at least one processor circuit is to assign first ones of the processor cores to the workload based on a lowest one of the first computation cost value or the second computation cost value.

7. The apparatus as defined in claim 6, wherein one or more of the at least one processor circuit is to assign second ones of the processor cores to the workload based on an unavailability status associated with the first ones of the processor cores.

8. At least one non-transitory machine-readable medium comprising machine-readable instructions to cause at least one processor circuit to at least:
generate groups of processor cores based on performance capability values;
assign a first one of the groups a first computation cost value based on (a) first ones of the performance capability values and (b) a first computation performance objective associated with a workload; and
assign a second one of the groups a second computation cost value based on (a) second ones of the performance capability values and (b) a second computation performance objective associated with the workload.

9. The at least one non-transitory machine-readable medium as defined in claim 8, wherein the machine-readable instructions are to cause one or more of the at least one processor circuit to:
identify the first computation performance objective as a power saving objective; and
assign a first processor core to the workload from the first one of the groups based on the workload including the first computation performance objective.

10. The at least one non-transitory machine-readable medium as defined in claim 9, wherein the machine-readable instructions are to cause one or more of the at least one processor circuit to assign the first processor core to the workload from the second one of the groups based on an availability status of ones of the processor cores in the first one of the groups.

11. The at least one non-transitory machine-readable medium as defined in claim 10, wherein the machine-readable instructions are to cause one or more of the at least one processor circuit to identify the availability status as at least one of unavailable or available after a threshold period of time.

12. The at least one non-transitory machine-readable medium as defined in claim 9, wherein the machine-readable instructions are to cause one or more of the at least one processor circuit to assign a second processor core to the workload from the second one of the groups based on an availability status of ones of the processor cores in the first one of the groups.

13. The at least one non-transitory machine-readable medium as defined in claim 8, wherein the machine-readable instructions are to cause one or more of the at least one processor circuit to assign first ones of the processor cores to the workload based on a lowest one of the first computation cost value or the second computation cost value.

14. The at least one non-transitory machine-readable medium as defined in claim 13, wherein the machine-readable instructions are to cause one or more of the at least one processor circuit to assign second ones of the processor cores to the workload based on an unavailability status associated with the first ones of the processor cores.

15. A method comprising:
generating, by at least one processor circuit programmed by at least one instruction, groups of processor cores based on performance capability values;
assign, by one or more of the at least one processor circuit, a first one of the groups a first computation cost value based on (a) first ones of the performance capability values and (b) a first computation performance objective associated with a workload; and
assign, by one or more of the at least one processor circuit, a second one of the groups a second computation cost value based on (a) second ones of the performance capability values and (b) a second computation performance objective associated with the workload.

16. The method as defined in claim 15, further including:
identifying the first computation performance objective is a power saving objective; and
assigning a first processor core to the workload from the first one of the groups based on the workload including the first computation performance objective.

17. The method as defined in claim 16, further including assigning the first processor core to the workload from the second one of the groups based on an availability status of ones of the processor cores in the first one of the groups.

18. The method as defined in claim 17, further including determining the availability status is at least one of unavailable or available after a threshold period of time.

19. The method as defined in claim 16, further including assigning a second processor core to the workload from the second one of the groups based on an availability status of ones of the processor cores in the first one of the groups.

20. The method as defined in claim 15, further including assigning first ones of the processor cores to the workload based on a lowest one of the first computation cost value or the second computation cost value.
